(19) United States
(12) Patent Application Publication
(10) Pub. No.: US 2023/0110757 A1
(43) Pub. Date: Apr. 13, 2023

(54) METHODS FOR TREATING ANIMALS, FEED, DRINKING WATER, WASH WATER, PROCESSING EQUIPMENT, PACKAGING MATERIALS, AND FOOD PRODUCTS

(71) Applicant: EVOQ NANO, INC., Salt Lake City, UT (US)

(72) Inventor: William H. Niedermeyer, West Jordan, UT (US)

(21) Appl. No.: 17/964,779

(22) Filed: Oct. 12, 2022

Related U.S. Application Data
(60) Provisional application No. 63/255,278, filed on Oct. 13, 2021.

(51) Int. Cl. A23B 4/24; B65B 25/00; A01K 13/00; A22B 5/00

(52) U.S. Cl. CPC A23B 4/24; B65B 25/001; A01K 13/003; A22B 5/0082; A23V 2002/00

(57) ABSTRACT

Disclosed are embodiments of nanoparticle compositions, methods and systems for disinfecting animals and food products along the whole food provision chain. In one embodiment, a composition includes nonionic metal nanoparticles. The composition may be a spray, an oil, a solution or other appropriate composition for ingestion or application to food products. The silver nanoparticles maintain a stead MIC and do not exhibit microbial resistance as do conventional colloidal silver and silver nanoparticles made by chemical synthesis.

### CROSS-REFERENCE TO RELATED APPLICATION

This application claims the benefit of U.S. Provisional Application No. 63/255,278, filed Oct. 13, 2021, which is incorporated by reference in its entirety.

### BACKGROUND

### Technical Field

This disclosure relates to nanoparticle compositions and methods for using such compositions for disinfecting animals and equipment along a whole food provision chain.

### Related Technology

Diseases old and new caused by microbes such as bacteria, fungi, and viruses, continue to plague humans, animals, and plants. In addition to infecting humans, sometimes as epidemics or pandemics, microbial diseases that affect animals and plants raised for food have and can continue to devastate food supplies and the food provision chain. Food products are also prone to spoilage as a result of microbes, particularly bacteria and fungi.

The food industry, especially the meat protein sector, suffers greatly in controlling the presence and growth of unwanted microbes. Unwanted microbes can arise at all levels, or stages, of the food provision chain. General stages of the food provision chain include production of food (fruits, vegetables and/or animals), handling and storage of produced food, processing and packaging of food, and distribution and retail of the final food products. Some microbes may enter the food provision chain through an infected animal, where the bacteria can then spread to other animals in proximity to the infected animal. Some microbes are present on surfaces where live animals are generally kept and maintained, including pen structures, floors, walls, tubes, feed transfer containers, etc.

Microbes may also be introduced when animals are brought to slaughter. When the animals are brought to slaughter they are washed down, where, for example, bacteria on the surface of their hides, skin, hair, and feathers contaminate the areas where the washing happens. For example, in the scalding tanks for birds, bacteria can be as high as 10∧8 in the tanks in a matter of 30 minutes after introduction of the birds.

The loss of animals to bacteria contamination is significant. For example, respiratory infections are a big concern for livestock. In some cases, 20-40% of animals being processed are rejected due to microbial issues or infections. Animal byproducts that can be heat processed to kill remaining microbes are a far less desirable and nutritious product. Although modern science has yielded many new antimicrobial compositions, some, such as antibiotics, are not always effective because microbes can build up tolerance or immunity to such compositions. In addition, apart from natural immunity and acquired immunity from vaccinations, there are no compositions that can reliably destroy or disable unwanted microbes.

Additionally, the overuse of antibiotics in the food industry has contributed to an overall anti-biotic resistance seen in newly discovered strains of microbes. There is concern that an increase in anti-biotic resistance of microbes may lead to “superbugs” that may be unable to be controlled with modern, conventional technologies. Currently, there are few conventional methods of disinfecting and microbial control without the use of antibiotics.

The problem of antimicrobial resistance has now been discovered for colloidal silver (traditional silver nanoparticles made by chemical processes) and ionic silver. McNeilly et al., “Emerging Concern for Silver Nanoparticle Resistance in Acinetobacter baumannii and Other Bacteria,” Front. Microbiol., 16 Apr. 2021, discuss the emergence of several antibiotic-resistant bacteria, including Acinetobacter baumannii, Enterococcus faecium, Staphylococcus aureus, Klebsiella pneumoniae, Acinetobacter baumannii, Pseudomonas aeruginosa, and Enterobacter spp. Of these, A. baumannii was of particular concern and was found to also have developed resistance to silver nanoparticles, as was E. Coli, Enterobacter cloacae, S. typhimurium, B. subtilis, S. aureus. P. aeruginosa, K. pneumoniae, Serratia marcescens, Acinetobacter spp.

Silver, “Bacterial silver resistance: molecular biology and uses and misuses of silver compounds,” FEMS Microbiology Reviews, Volume 27, Issue 2-3, June 2003, Pages 341-35, discusses silver-resistant Salmonella, and Escherichia coli. Elkrewi, et al., “Cryptic silver resistance is prevalent and readily activated in certain Gram-negative pathogens,” J Antimicrob Chemother, 2017 Nov. 1;72(11):3043-3046 discloses silver nanoparticle resistance by gram negative pathogens, such as Enterobacter spp., Klebsiella spp. Escherichia coli, Pseudomonas aeruginosa, Acinetobacter spp., Citrobacter spp., and Proteus spp. Hosney, “The increasing threat of silver-resistance in clinical isolates from wounds and burns,” Infect Drug Resist. 2019; 12: 1985-2001 discusses silver-resistant Klebsiella pneumoniae, Staphylococcus aureus, Escherichia coli, Enterobacter cloacae, Pseudomonas aeruginosa, and Acinetobacter baumannii. Percival, et al., “Bacterial resistance to silver in wound care, Journal of Hospital Infection, Vol. 60, Issue 1, May 2005, pp. 1-7, discusses the fear and possibility of silver-resistant microbes in wounds. Kȩdziora, et al., “Consequences Of Long-Term Bacteria's Exposure To Silver Nanoformulations With Different PhysicoChemical Properties,” International Journal of Nanomedicine, 2020:15 199-213, discusses silver-resistant gram positive and gram negative bacteria.

An article entitled “Are Silver Nanoparticles a Silver Bullet Against Microbes?” Jul. 13, 2021, https://news.engineering.pitt.edu/are-silver-nanoparticles-a-silver-bullet-against-microbes/(accessed Oct. 12, 2022), discusses silver nanoparticle resistant E. coli., stating: “‘In the beginning, bacteria could only survive at low concentrations of silver nanoparticles, but as the experiment continued, we found that they could survive at higher doses . . . . Interestingly, we found that bacteria developed resistance to the silver nanoparticles but not their released silver ions alone.’ The group sequenced the genome of the E. coli that had been exposed to silver nanoparticles and found a mutation in a gene that corresponds to an efflux pump that pushes heavy metal ions out of the cell. ‘It is possible that some form of silver is getting into the cell, and when it arrives, the cell mutates to quickly pump it out . . . . More work is needed to determine if researchers can perhaps overcome this mechanism of resistance through particle design.’”

### SUMMARY

Disclosed are embodiments of nanoparticle compositions, methods, and systems for using metal (e.g., silver) nanoparticles to disinfect animals, processing equipment, and food products along the whole food provision chain. In one embodiment, a composition includes nonionic silver nanoparticles formed by laser ablation. Surprisingly and unexpectedly, the nonionic silver nanoparticles formed by laser ablation did not lead to silver nanoparticle resistance, as occurs when using traditional colloidal silver and silver nanoparticles made by chemical synthesis and which are known release silver ions as their main mode of antimicrobial activity.

The nanoparticle composition may be a spray, an oil, a solution, or other appropriate composition for application to animals, living areas, feeding apparatus, feed and water, wash water to clean animals before and during slaughter, food packaging materials, food processing equipment, and food products in the food provision chain. The composition may be effective against bacteria, fungi and/or viruses.

In some embodiments, a metal nanoparticle composition may comprise (1) a carrier and (2) a plurality of metal (e.g., silver) nanoparticles having a particle size and a particle size distribution selected so as to selectively and preferentially kill a target microbe selected from bacteria, fungi, and viruses. The metal nanoparticles are advantageously nonionic, ground state, with no external edges or bond angles that can release metal ions. Spherical metal nanoparticles are typically used to kill microbes, although coral-shaped metal nanoparticles can provide anti-microbial activity, typically in combination with spherical metal nanoparticles. Unexpectedly, such spherical silver nanoparticles did not result in microbial resistance, thus solving a tremendous problem with traditional antibiotics, silver compounds, colloidal silver, and silver nanoparticles.

Where the targeted microbe is a bacterium, anti-bacterial compositions can include spherical metal (e.g., silver) nanoparticles having a particle size in a range of about 3 nm to about 14 nm, or about 5 nm to about 13 nm, or about 7 nm to about 12 nm, or about 8 nm to about 10 nm. Within these size ranges it is possible to select “designer anti-bacterial particles” of specific size that are particularly effective in targeting a specific bacterium.

Where the targeted microbe is a fungus, anti-fungal compositions can include spherical metal (e.g., silver) nanoparticles having a particle size in a range of about 9 nm to about 20 nm, or about 10 nm to about 18 nm, or about 11 nm to about 16 nm, or about 12 nm to about 15 nm. Within these size ranges it is possible to select “designer anti-fungal particles” of specific size that are particularly effective in targeting a specific fungus.

Where the targeted microbe is a virus, anti-viral compositions can include metal (e.g., silver) nanoparticles having a particle size in a range of about 8 nm or less, or about 1 nm to about 7 nm, or about 2 nm to about 6.5 nm, or about 3 nm to about 6 nm. Within these size ranges it is possible to select “designer anti-viral particles” of specific size that are particularly effective in targeting a specific virus.

In some embodiments, a method of killing or deactivating a target microbe comprises: (1) applying an antimicrobial composition comprising a carrier and metal (e.g., silver) nanoparticles onto or into a substrate containing target microbes, and (2) the antimicrobial composition killing or deactivating the target microbes. The substrate can be a living organism or a non-living object or surface. Unexpectedly, this process can be repeated without causing silver nanoparticle resistance.

In some embodiments, spherical metal (e.g., silver) nanoparticles having a mean diameter (number average) and a particle size distribution in which at least 99% of the spherical metal nanoparticles have a particle size within 30% of the mean diameter, or within 20% of the mean diameter, or within 10% of the mean diameter and/or wherein at least 99% of the spherical metal nanoparticles have a diameter within ±3 nm of the mean diameter, or within ±2 nm of the mean diameter, or within ±1 nm of the mean diameter.

In some embodiments, the compositions may comprise coral-shaped metal nanoparticles in addition to the spherical metal nanoparticles. Coral-shaped metal (e.g., gold) nanoparticles have a non-uniform cross section and a globular structure formed by multiple, non-linear strands joined together without right angles. In some cases, the coral-shaped metal nanoparticles can be used to potentiate the effect of spherical metal (e.g., silver) nanoparticles.

In some embodiments, metal nanoparticles can comprise at least one metal selected from the group consisting of silver, gold, platinum, palladium, rhodium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, and alloys thereof. Nanoparticles comprised of silver, gold, and mixtures and alloys thereof can be particularly effective.

The metal nanoparticles are designed to kill microbes such as bacteria, fungi, and viruses without the release of any silver (Ag+) or other metal ions. Because the metal nanoparticles do not release detectable numbers of silver or other metal ions, they are essentially non-toxic to humans and other animals (i.e., whatever amount or concentration of ions, if any, that are released from the metal nanoparticles is far below the threshold toxicity level at which they become toxic to humans, other mammals, birds, reptiles, fish, and amphibians).

In some embodiments, objects and surfaces present in the living quarters of the animals (pen structures, floors, walls, etc.) can be treated with the metal (e.g., silver) nanoparticle composition to kill or deactivate microbes. Such treatment can be performed by direct application, wiping, spraying, misting, fogging. Where the living area contains animals therein, the metal nanoparticle composition can treat animal surfaces, such as skin and fur. If inhaled by the animals, the metal nanoparticle compositions can kill microbes in the respiratory tract of the animals in order to therapeutically or prophylactically treat microbial diseases of the respiratory tract.

In some embodiments, metal (e.g., silver) nanoparticles can be incorporated into animal feed and drinking water to therapeutically or prophylactically treat microbial diseases of the gastrointestinal tract. The metal nanoparticles can also help preserve the feed and prevent spoilage. The metal nanoparticles can also disinfect the drinking water. The metal nanoparticles can provide an anti-corrosion effect of metal pipes used to provide the drinking water.

In some embodiments, metal (e.g., silver) nanoparticles are included in the wash water used in the washing animals in preparation for and/or during slaughter. Including metal nanoparticles in the washing water can kill or prevent bacteria from growing during animal slaughtering and food processing. For example, in scalding tanks for birds, bacteria can grow to as high as 10∧8 in a matter of 30 minutes. Introducing the metal nanoparticles into the scalding tanks will control the bacteria from pluming as the metal nanoparticles do not change and are not deactivated at elevated temperature and can be controlled in concentrations by temperature gradients between the carcass and the hot water. Throughout the rest of the processing, the use of metal nanoparticles in the processing water controls microbial growth in water being pumped in, circulated internally, and discharged.

In some embodiments, the metal (e.g., silver) nanoparticles are effective at about 0.5 mg/L to about 10 mg/L concentrations (about 0.5 ppm to about 10 ppm), meaning they are far less toxic than conventional disinfectants, such as peracetic acid, bromine chemistry, and peroxide chemistries at concentrations required to provide microbial control. The peracetic acid, bromine chemistry, and peroxide chemistries may be limited in their concentrations due to the damage they cause to proteins, while the metal nanoparticles do not cause such damage. The metal nanoparticles thus may be used to enhance the microbial control of peracetic acid, bromine chemistry, and peroxide chemistries at far lower concentrations than generally used. The metal nanoparticles have no microbial resistance as the mode of action is via catalytic disulfide bond cleavage in surface proteins, causing the microbial death without lysing them. Using metal nanoparticles with microwave induction increases local super heating of microbes to control them via flash heating using microwave and electron emission technologies.

In some embodiments, the metal (e.g., silver) nanoparticles can be incorporated into the food packaging used to store, ship, and display food, such as thermoplastic wraps, polystyrene trays, bottles, cans, or other suitable food packaging materials. The use of the metal nanoparticles throughout the food processing chain ensures control of microbes in line with the tightened controls of the FDA and USDA.

In some embodiments, the metal (e.g., silver) nanoparticle compositions may be used in all stages in the food provision chain to disinfect processing equipment, such as cutting equipment, canning equipment, packaging equipment, and the like.

In some embodiments, the metal (e.g., silver) nanoparticles can be applied to food products, such as meat or vegetables, to control microbes during processing, shipment, and storage of the food products.

Examples of metal (e.g., silver and gold) nanoparticles and nanoparticle compositions that can be used herein are disclosed in U.S. Pat. Nos. 9,849,512, 9,434,006, 9,919,363, 10,137,503, and 10,610,934, which are incorporated herein by reference.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIGS. 1A-1D show TEM images of various non-spherical nanoparticles (i.e., that have surface edges and external bond angles) made according to conventional chemical synthesis or electrical discharge methods;

FIGS. 2A-2C show TEM images of exemplary nonionic spherical-shaped metal nanoparticles (i.e., that have no surface edges or external bond angles), the nanoparticles showing substantially uniform size and narrow particle size distribution, smooth surface morphology, and solid metal cores without the use of coating agents;

FIGS. 3A-3C show transmission electron microscope (TEM) images of nonionic coral-shaped nanoparticles;

FIGS. 4A-4C schematically illustrated a proposed mechanism of action by which the nanoparticles can kill or deactivate bacteria; and

FIG. 5 illustrates the results of conductivity testing comparing various nanoparticle solutions and showing that spherical, metal nanoparticles according to the disclosed embodiments are nonionic.

### DETAILED DESCRIPTION

Disclosed are embodiments of nanoparticle compositions, methods, and systems for using nanoparticles to disinfect animals, equipment, and food products along the whole food provision chain. Compositions includes nonionic metal (e.g., silver) nanoparticles. Surprisingly and unexpectedly, the nonionic silver nanoparticles formed by laser ablation did not lead to silver nanoparticle resistance, as occurs when using traditional colloidal silver and silver nanoparticles made by chemical synthesis and which are known release silver ions as their main mode of antimicrobial activity.

The nanoparticle composition may be a spray, an oil, a solution or other appropriate composition for application to animals, living areas, feeding apparatus, feed and water, wash water to clean animals before and during slaughter, food packaging materials, food processing equipment, and food products in the food provision chain. The composition may be effective against bacteria, fungi and/or viruses.

I. Introduction

The term “nanoparticle” often refers to particles having a largest dimension of less than 100 nm. Bulk materials typically have constant physical properties regardless of size, but at the nanoscale, size dependent properties are often observed. Thus, properties of materials change as their size approaches the nanoscale and as the percentage of atoms at the surface of a material becomes significant. For bulk materials larger than one micrometer (or micron), the percentage of atoms at the surface is insignificant in relation to the number of atoms in the bulk of the material. The interesting and sometimes unexpected properties of nanoparticles are therefore largely due to the large surface area of the material, which dominates the contributions made by the relatively small bulk of the material.

The ability to select and use metal nanoparticles that can target specific types or classes of microbes provides a number of benefits. In the case where only certain nanoparticle sizes are effective in killing a particular microbe or class of microbes, providing metal nanoparticles within a narrow particle size distribution of the correct particle size maximizes the proportion of nanoparticles that are effective in killing the target microbe and minimizes the proportion of nanoparticles that are less effective, or ineffective, in killing the target microbe. This, in turn, greatly reduces the overall amount or concentration of nanoparticles required to provide a desired kill- or deactivation rate of a targeted microbe. Eliminating improperly sized nanoparticles also reduces the tendency of the composition to kill or harm non-targeted microbes or other cells, such as healthy mammalian or human cells. In this way, highly specific antimicrobial compositions can better target a harmful microbe while being less harmful or even non-toxic to humans, animals, and plants.

Moreover, because it has now been discovered that the nonionic metal nanoparticles formed by laser ablation do not result in antimicrobial resistance, which is unexpected given the extensive data for other silver nanoparticles, the concentration of silver nanoparticles required to effectively kill microbes remains essentially the same. This is in contrast to silver nanoparticles made by chemical processes, which have external bond angles and typically release silver ions as part of their antimicrobial activity.

In some embodiments, a metal nanoparticle composition may comprise (1) a carrier and (2) a plurality of metal (e.g., silver) nanoparticles having a particle size and a particle size distribution selected so as to selectively and preferentially kill a target microbe selected from bacteria, fungi, and viruses. The metal (e.g., silver) nanoparticles are advantageously nonionic, ground state, with no external edges or bond angles that can release metal ions. Spherical metal (e.g., silver) nanoparticles are typically used to kill microbes, although coral-shaped metal nanoparticles can potentiate and/or provide anti-microbial activity, typically in combination with spherical metal nanoparticles.

In some embodiments, the metal nanoparticles may comprise or consist essentially of nonionic, ground state metal (e.g., silver) nanoparticles with no external edges or bond angles that can release metal ions (i.e., without such external edges or bond angles, no metal ions are detected even after years of storage in water). Examples include spherical metal nanoparticles, coral-shaped metal nanoparticles, and blends of spherical metal nanoparticles and coral-shaped metal nanoparticles.

II. Nanoparticle Details

Metal nanoparticles and nanoparticle compositions typically include nonionic, ground state, metal nanoparticles with no external edges or bond angles that can otherwise release metal ions. Nanoparticle compositions may include spherical metal nanoparticles, coral-shaped metal nanoparticles or a combination of the two. Spherical metal nanoparticles are typically used to kill microbes, although coral-shaped metal nanoparticles can provide anti-microbial activity, typically in combination with spherical metal nanoparticles.

Nonionic, ground state, spherical metal nanoparticles with no external edges or bond angles that can otherwise release metal ions, and compositions containing such nanoparticles, can be made according to the disclosure of U.S. Pat. Nos. 9,849,512, 10,137,503, and 10,610,934. Nonionic, ground state, coral-shaped metal nanoparticles with no external edges or bond angles that can otherwise release metal ions, and compositions containing such nanoparticles, can be made according to the disclosure of U.S. Pat. No. 9,919,363. Compositions that contain a mixture of spherical metal nanoparticles and coral-shaped metal nanoparticles are disclosed in U.S. Pat. No. 9,434,006. The foregoing patents are incorporated herein by reference in their entirety.

The metal nanoparticles, including spherical and coral-shaped nanoparticles, may comprise any desired metal, mixture of metals, or metal alloy, including at least one of silver, gold, platinum, palladium, rhodium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, or alloys thereof. Nanoparticles comprised of silver, gold, and mixtures and alloys thereof can be particularly effective.

In some embodiments, nanoparticle compositions can include nanoparticles in a narrow concentration range of 1 to 2 mg/L or 1 to 2 mg/kg (1 to 2 ppm). In some embodiments, the compositions may include nanoparticles in a concentration of 1.25 to 1.75 mg/L (1.25 to 1.75 ppm). In some embodiments, the compositions may include nanoparticles in a concentration of 1.5 mg/L (1.5 ppm) to 4.75 mg/L (4.75 ppm). Alternatively, nanoparticle compositions may include nanoparticles in a concentration of about 50 ppb to about 100 ppm, or about 100 ppb to about 50 ppm, or about 200 ppb to about 20 ppm, or about 400 ppb to about 10 ppm, or about 600 ppb to about 6 ppm, or about 800 ppb to about 4 ppm, or about 1 ppm to 3 ppm, or about 2 ppm. The compositions may include nanoparticles in a concentration range with endpoints defined by any two of the foregoing values of this paragraph.

a. Conventional Nanoparticles

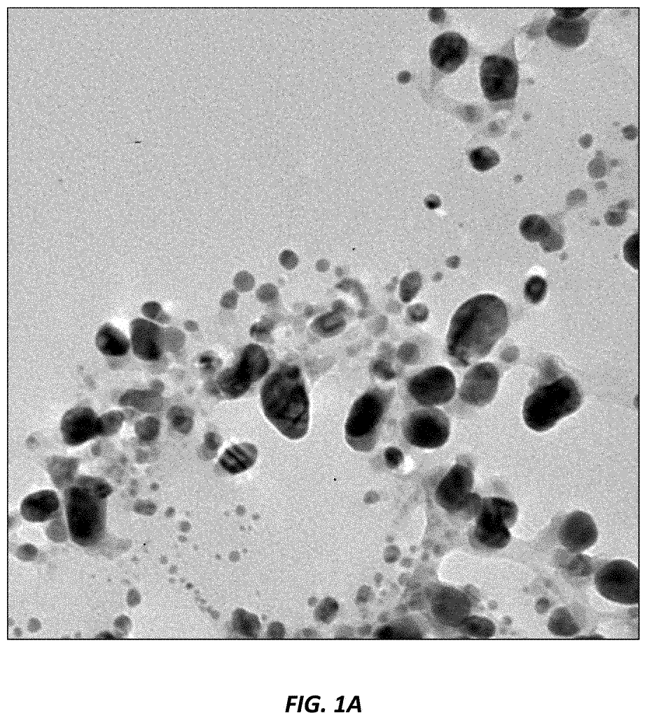

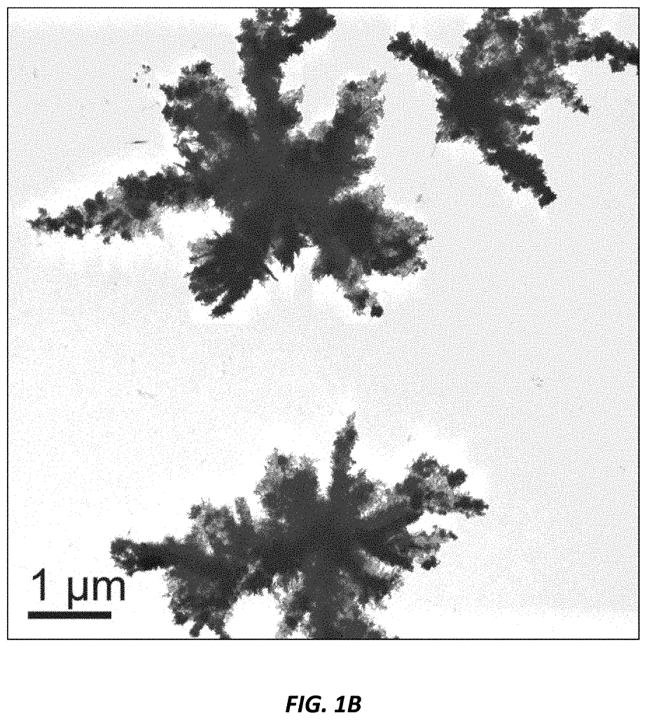

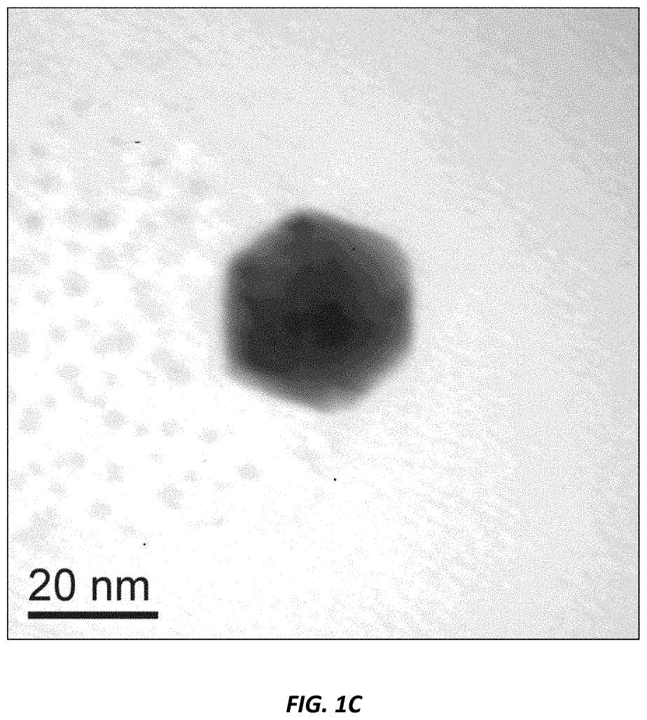

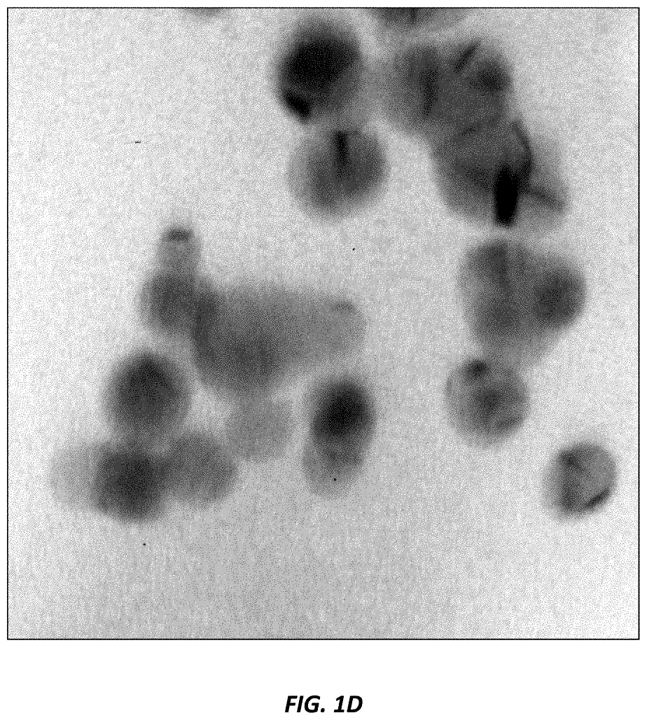

FIGS. 1A-1D show transmission electron microscope (TEM) images of conventional or traditional nanoparticles made according to various chemical synthesis methods. As shown, the nanoparticles formed using these various chemical synthesis methods tend to exhibit a clustered, crystalline, faceted, or hedron-like shape rather than a true spherical shape with round and smooth surfaces.

For example, FIG. 1A shows silver nanoparticles formed using a common trisodium citrate method. The nanoparticles are clustered and have a relatively broad size distribution. FIG. 1B shows another set of silver nanoparticles (available from American Biotech Labs, LLC) formed using another chemical synthesis method and showing rough surface morphologies with many edges. FIG. 1C shows a gold nanoparticle having a hedron shape as opposed to a truly spherical shape. FIG. 1D shows a set of silver nanoparticles (sold under the trade name MesoSilver), which have relatively smoother surface morphologies but are understood to be shells of silver formed over a non-metallic seed material.

As discussed in the Background section, conventional silver nanoparticles made using chemical processes are known to cause antimicrobial resistance, meaning their effective in killing microbes diminishes over time. Some studies have shown microbial resistance to ionic silver in only 6 passages or generations.

b. Spherical Nanoparticles

In contrast to conventional nanoparticles such as shown in FIGS. 1A-1D, which lose their antimicrobial effectiveness over time to a variety of bacteria and other microbes, the spherical-shaped nanoparticles described herein are solid metal, substantially unclustered, optionally exposed/uncoated, and have a smooth and round surface morphology along with a narrow size distribution. They have been shown to have stable anti-microbial activity even after 28 passages, with no diminution of antimicrobial activity, such as no reduction in the MIC (minimum inhibitory concentration).

The term “spherical metal nanoparticles” refers to nanoparticles that are made from one or more metals, preferably nonionic, ground state metals, having only internal bond angles and no external edges or bond angles. In this way, the spherical nanoparticles are highly resistant to ionization, highly stable, and highly resistance to agglomeration. Such nanoparticles can exhibit a high ζ potential, which permits the spherical nanoparticles to remain dispersed within a polar solvent without a surfactant. In some embodiments, spherical nanoparticles have a ζ potential of at least ±10 mV (absolute value), preferably at least about ±15 mV, more preferably at least about ±20 mV, even more preferably at least about ±25 mV, and most preferably at least about ±30 mV.

In some embodiments, spherical metal nanoparticles have a mean diameter (number average) and a particle size distribution in which at least 99% of the metal nanoparticles have a particle size within 30% of the mean diameter, or within 20% of the mean diameter, or within 10% of the mean diameter and/or wherein at least 99% of the spherical-shaped nanoparticles have a diameter within ±3 nm of the mean diameter, or within ±2 nm of the mean diameter, or within ±1 nm of the mean diameter.

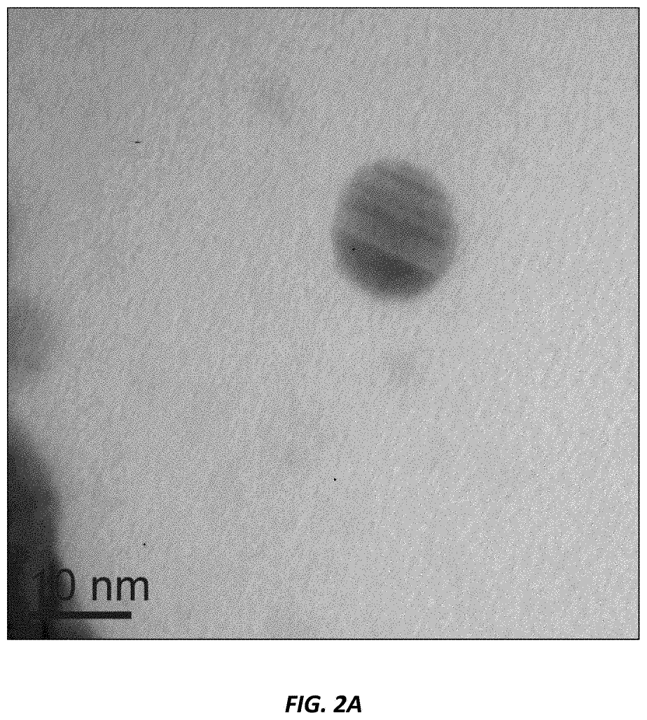

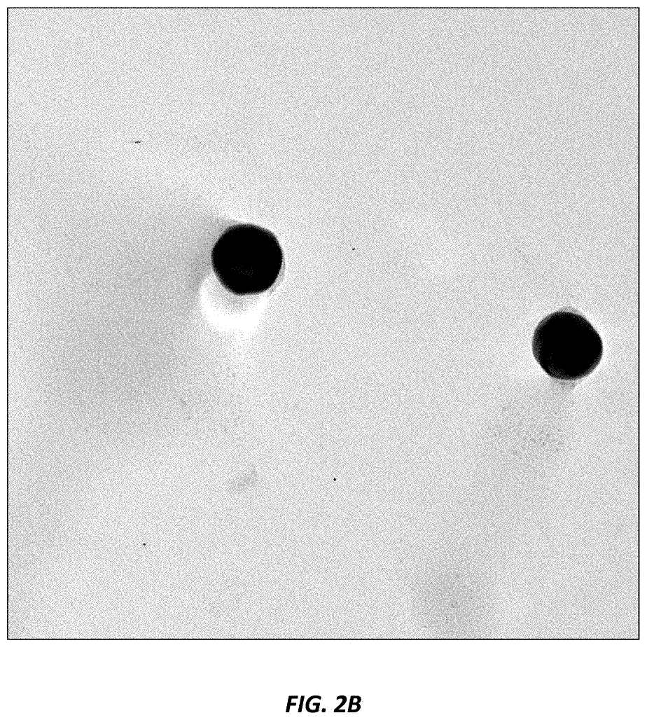

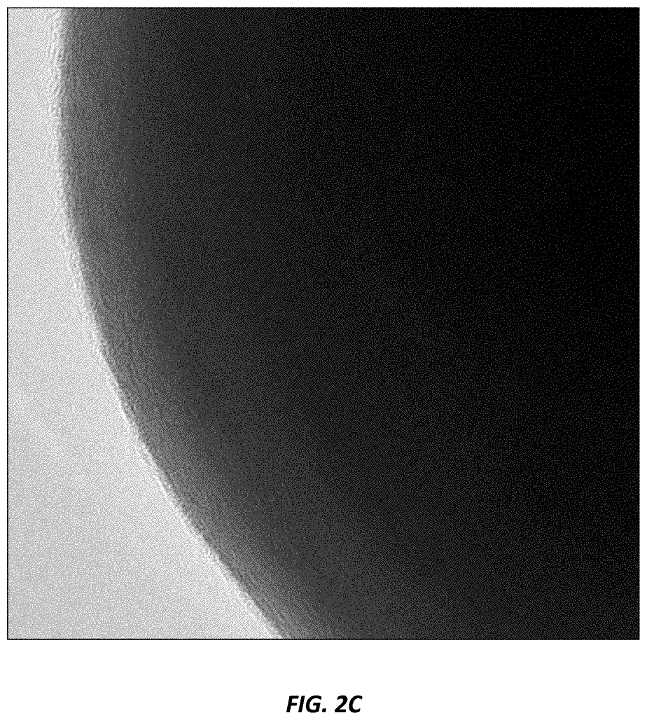

FIGS. 2A-2C show TEM images of spherical-shaped nanoparticles. FIG. 2A shows a gold/silver alloy nanoparticle (90% silver and 10% gold by molarity). FIG. 2B shows two spherical nanoparticles side by side to visually illustrate size similarity. FIG. 2C shows a surface of a metal nanoparticle showing the smooth and edgeless surface morphology.

Where the targeted microbe is a bacterium, anti-bacterial compositions can include spherical metal nanoparticles having a particle size in a range of about 3 nm to about 14 nm, or about 5 nm to about 13 nm, or about 7 nm to about 12 nm, or about 8 nm to about 10 nm. Within these size ranges it is possible to select “designer anti-bacterial particles” of specific size that are particularly effective in targeting a specific bacterium.

Where the targeted microbe is a fungus, anti-fungal compositions can include spherical metal nanoparticles having a particle size in a range of about 9 nm to about 20 nm, or about 10 nm to about 18 nm, or about 11 nm to about 16 nm, or about 12 nm to about 15 nm. Within these size ranges it is possible to select “designer anti-fungal particles” of specific size that are particularly effective in targeting a specific fungus.

Where the targeted microbe is a virus, anti-viral compositions can include metal nanoparticles having a particle size in a range of about 8 nm or less, or about 1 nm to about 7 nm, or about 2 nm to about 6.5 nm, or about 3 nm to about 6 nm. Within these size ranges it is possible to select “designer anti-viral particles” of specific size that are particularly effective in targeting a specific virus.

c. Coral-Shaped Nanoparticles

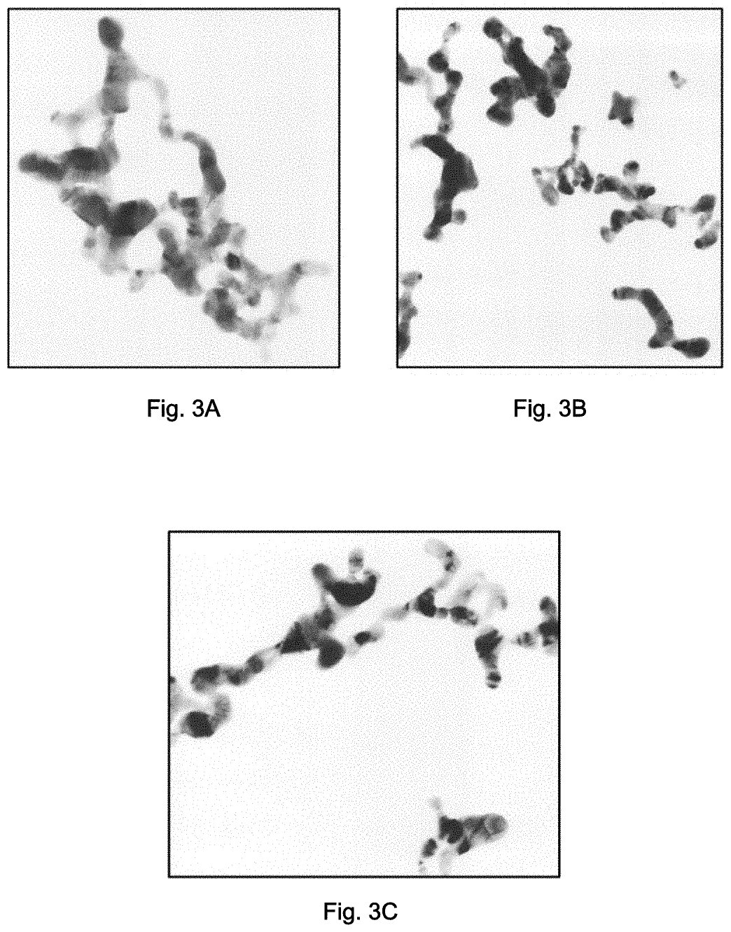

In some embodiments, metal nanoparticles can comprise coral-shaped metal nanoparticles. The term “coral-shaped metal nanoparticles” refers to nanoparticles that are made from one or more metals, preferably nonionic, ground state metals having a non-uniform cross section and a globular structure formed by multiple, non-linear strands joined together without right angles (see FIGS. 3A-3C). Similar to spherical nanoparticles, coral-shaped nanoparticles may have only internal bond angles and no external edges or bond angles. In this way, coral-shaped nanoparticles are highly resistant to ionization, highly stable, and highly resistance to agglomeration. Such coral-shaped nanoparticles exhibit a high ∂ potential, which permits coral-shaped nanoparticles to remain dispersed within a polar solvent without a surfactant. In some embodiments, coral-shaped metal nanoparticles can be used together with spherical metal nanoparticles (e.g., to potentiate the spherical metal nanoparticles).

In some embodiments, coral-shaped nanoparticles can have lengths ranging from about 15 nm to about 100 nm, or about 25 nm to about 95 nm, or about 40 nm to about 90 nm, or about 60 nm to about 85 nm, or about 70 nm to about 80 nm. In some embodiments, coral-shaped nanoparticles can have a particle size distribution in which at least 99% of the nanoparticles have a length within 30% of the mean length, or within 20% of the mean length, or within 10% of the mean length. In some embodiments, coral-shaped nanoparticles have a ζ potential of at least ±10 mV (absolute value), preferably at least about ±15 mV, more preferably at least about ±20 mV, even more preferably at least about ±25 mV, and most preferably at least about ±30 mV.

III. Antimicrobial Activity of Nanoparticles

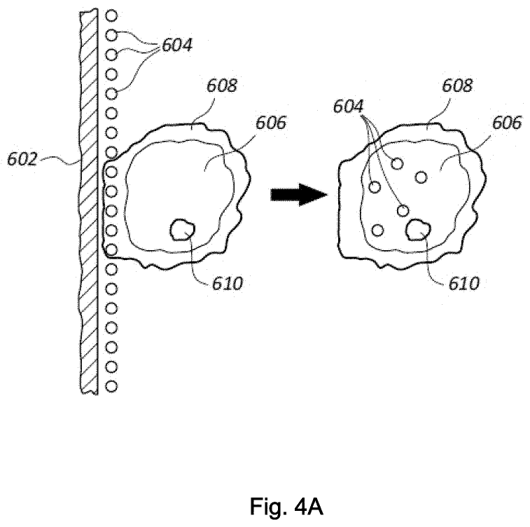

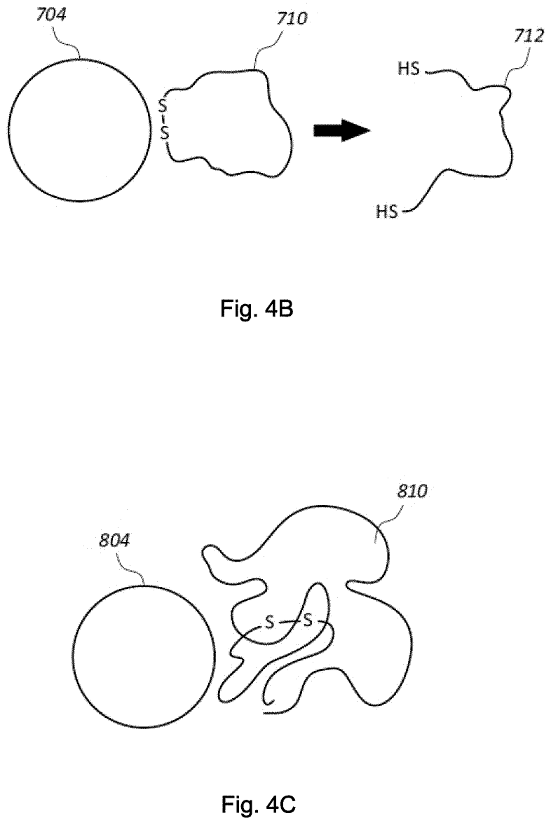

FIGS. 4A-4C illustrate the microbe-specific action of the metal nanoparticles while leaving mammalian tissues largely unharmed.

FIG. 4A schematically illustrates a bacterium 608 having absorbed spherical-shaped nanoparticles 604 from a substrate 602 (e.g., from a mucus layer), such as by active absorption or other transport mechanism. The nanoparticles 604 can freely move throughout the interior 606 of bacterium 608 and come into contact with one or more vital proteins or enzymes 610 that, if denatured, will kill or disable the bacterium. A similar mechanism may function where viral or fungal pathogens are involved. Unlike most conventional antibiotics, the nanoparticles effectively kill or deactivate the bacterium without significantly disrupting the cell wall and therefore without significant lysing of the bacteria coming into contact with the nanoparticles.

For example, one way that nanoparticles may kill or denature a microbe is by catalyzing the cleavage of disulfide (S—S) bonds within a vital protein or enzyme. FIG. 4B schematically illustrates a microbe protein or enzyme 710 with disulfide bonds being catalytically denatured by an adjacent spherical-shaped nanoparticle 704 to yield denatured protein or enzyme 712. In the case of bacteria or fungi, the cleavage of disulfide bonds and/or cleavage of other chemical bonds of vital proteins or enzymes may occur within the cell interior and thereby function to kill the microbe in this manner without causing significant lysis. Such catalytic cleavage of disulfide (S—S) bonds is facilitated by the generally simple protein structures of microbes, in which many vital disulfide bonds are on exposed and readily cleaved by catalysis.

Another potential mechanism by which metal (e.g., silver) nanoparticles can kill microbes is through the production of active oxygen species, such as peroxides, which can oxidatively cleave protein bonds, including but not limited to amide bonds.

Notwithstanding the lethal nature of nonionic metal nanoparticles relative to microbes, they are essentially harmless and non-toxic to humans, mammals, and healthy mammalian cells, which contain much more complex protein structures compared to simple microbes in which most or all vital disulfide bonds are shielded by other, more stable regions of the protein. FIG. 4C schematically illustrates a mammalian protein 810 with disulfide (S—S) bonds that are shielded so as to resist being catalytically denatured by an adjacent spherical-shaped nanoparticle 804. In many cases the nonionic nanoparticles do not interact with or attach to human or mammalian cells and can be quickly and safely expelled through the urine without damaging kidneys or other cells, tissues, or organs.

The metal (e.g., silver) nanoparticles kill bacteria without significant release of silver (Ag+) or other metal ions. Because the metal nanoparticles do not release significant quantities of silver or other metal ions, they are essentially non-toxic to humans and other animals (i.e., whatever amount or concentration of ions, if any, that are released from the metal nanoparticles is/are below a threshold toxicity level at which they become toxic to humans, other mammals, birds, reptiles, fish, and amphibians). Nonetheless, they retain their antimicrobial activity without evidence of microbial resistance.

In the particular case of silver (Ag) nanoparticles, the interaction of the silver (Ag) nanoparticle(s) within a microbe has been demonstrated to be particularly lethal without the need to rely on the production of silver ions (Ag⁺) to provide the desired antimicrobial effects, as is typically the case with conventional colloidal silver compositions. The ability of silver (Ag) nanoparticles to provide effective microbial control without any significant or actual release of toxic silver ions (Ag⁺) into the patient or the surrounding environment is a substantial advancement in the art. Whatever amount or concentration of silver ions released by silver nanoparticles, if any, is well below known or inherent toxicity levels for animals, such as mammals, birds, reptiles, fish, and amphibians.

As used herein, the modifying term “significant” means that the effect the term is modifying is clinically noticeable and relevant. Thus, the phrase “without significant release of silver ions” means that though there may technically be some small amount of detectable ion release, the amount is so small as to be clinically and functionally negligible. Similarly, the phrase “without significant cell lysis” means that although there may be some observable cell lysis, the amount is negligible and only tangentially related to the actual primary mechanism of cell death/deactivation.

In some embodiments, the nanoparticle composition includes nanoparticles in a concentration of 1 to 2 mg/L (1 to 2 ppm). In some embodiments, the composition also includes sodium laurel sulfate (SLS) at levels that are not independently antimicrobial. When SLS is mixed with Ag nanoparticles, the Ag nanoparticles have significantly higher antimicrobial effect. This is because the SLS encourages the uptake of nanoparticles associated with SLS into bacteria or other microbes. Alternatively, nanoparticle compositions may include nanoparticles in a concentration of about 50 ppb to about 100 ppm, or about 100 ppb to about 50 ppm, or about 200 ppb to about 20 ppm, or about 400 ppb to about 10 ppm, or about 600 ppb to about 6 ppm, or about 800 ppb to about 4 ppm, or about 1 ppm to 3 ppm, or about 2 ppm. The compositions may include nanoparticles in a concentration range with endpoints defined by any two of the foregoing values of this paragraph.

IV. Using Nanoparticles and Nanoparticle Compositions in the Food Provision Chain

a. Living Areas & Feed Apparatus of Animals

In conventional food provision chains, animals often live in close proximity to one another, making the spread of microbes fast and relatively easy. In some embodiments, materials present in the living quarters of animals may be sprayed, coated or impregnated with a composition including metal nanoparticles. The metal nanoparticles may act as a processing aid, preventing buildup of pathogens or microbes in the living quarters. The metal nanoparticles may act as a preservative in preventing buildup of microbes in the food provision chain. As a processing aid, the metal nanoparticles may not be a final ingredient in a product line.

In some embodiments, materials present in the living quarters of the animals (pen structures, floors, walls, etc.) may be sprayed, coated or embedded with the metal nanoparticles to control microbes on surfaces of the living quarters. In one embodiment, the metal nanoparticles are included, as a processing aid, in a cooling system present in the living quarters to keep the animals cool. An example is an evaporative cooler in which metal nanoparticles are added to the water and/or the pads. The animals can breathe in the cooled air containing metal nanoparticles for therapeutic or prophylactic treatment. Metal nanoparticles may be included in misters to cool the living area and administer the nanoparticles to the animals. The metal nanoparticles may land on the floors, walls, pen structures, hay, etc. in the living quarters of the animals. The metal nanoparticles may land on the skin or hide of animals and/or the animals may inhale the metal nanoparticles present in the mist. In some embodiments, inhalation of the metal nanoparticles by animals may treat or reduce the risk of respiratory infections.

The antimicrobial compositions described herein are able to effectively penetrate thick, viscous mucus layers that may be present in the lungs of livestock or other animals to reach targeted microbes within the mucus and to reach underlying respiratory tissue. This beneficially allows the treatment composition to reach and treat underlying infected respiratory tissue. In addition, it allows the treatment composition to reach bacteria or other microbes within the mucus and associated biofilm layers in which the bacteria tend to lie in wait shielded from conventional antibiotics. Notwithstanding the effective penetrative abilities of the nanoparticles of the treatment compositions described herein, they are also capable of being effectively cleared from the patient through normal clearance routes and thereby avoid building up within the treated respiratory tissue or other tissues or organs of the body.

In one embodiment, a method of treating a livestock respiratory infection comprises administering the nanoparticle treatment composition to an animal subject via inhalation, and the treatment composition treating the respiratory infection. The infection may be, for example, caused by one or more antibiotic resistant bacteria. The treatment composition is beneficially able to kill or deactivate bacteria associated with the infection without harming respiratory epithelia and other nearby tissues.

In some embodiments, the metal nanoparticles may be embedded or incorporated into a feeding apparatus or feeding equipment. The metal nanoparticles may prevent microbial buildup in the feeding apparatus or equipment. The prevention of microbial buildup in the feeding apparatus or equipment may prevent microbial buildup in other areas of the living quarters.

In some embodiments, a method of killing or deactivating a microbe comprises: (1) applying an antimicrobial composition comprising a carrier and metal nanoparticles onto or into a substrate containing or prone to contain microbes, and (2) the antimicrobial composition killing or deactivating the microbes. The substrate can be a living organism or a non-living object.

b. Incorporating Nanoparticles into Animal Food and Water

In one embodiment, metal nanoparticles may be directly added to the food and water of animals to therapeutically or prophylactically treat gastrointestinal (GI) tract and other diseases. In one embodiment, infected animals can be treated by putting the metal nanoparticles directly into the feed and/or water provided to animals. In some embodiments, the metal nanoparticles are included in a fluid for best dispersion and diffusion of the metal nanoparticles in the feed and/or water provided to animals. For example, the metal nanoparticles may be included in a liquid that is subsequently sprayed or misted onto the feed.

In some embodiments, the metal nanoparticles are added to the feed during the feed manufacturing process. In some embodiments, the metal nanoparticles are added to the feed after the manufacturing process at an animal processing facility, such as, for example, a feed lot. In some embodiments, the metal nanoparticles may be sprayed onto to the feed using misters during a mixing or moisture control process (sch as when adding minerals or vitamins to the feed stock).

In some embodiments, the metal nanoparticles are dispersed in water and/or are added to the water animals will drink. In some embodiments, the metal nanoparticles would be added to the water as a concentrate by a metered system that would mix the particles with the existing flow lines. In the case of metal pipes, the metal nanoparticles may help prevent corrosion (e.g., by depositing on metallic surfaces and/or preventing growth of bacteria that can acidify the water).

The metal nanoparticles can act as a preservative, preventing the buildup of unwanted microbes in the food and/or water provided to animals, preserving the shelf life of animal feed. The metal nanoparticles may also act as a medicine, treating GI tract or other microbial infections after ingestion by an animal. The metal nanoparticles may come into contact with one or more vital microbial proteins and denature the one or more vital proteins. Such denaturation disables or kills the microbe without lysing the microbe.

In some embodiments, the nanoparticles may be included in the feed and/or water at an effective concentration of 1 to 2 mg/kg or 1 to 2 mg/L (1 to 2 ppm), respectively. In some embodiments, general concentrations of 10 to 20 mg/L or 10 to 20 mg/kg are used that can be reduced (by dilution) to the 1 to 2 mg/kg or 1 to 2 mg/L range.

In some embodiments, an antimicrobial composition can be formulated so that the metal nanoparticles are included in a concentration so that a measured quantity of the nanoparticle composition, when applied onto or into an organism or organism part, will provide a predetermined concentration or quantity of metal nanoparticles. The nanoparticle composition can have a higher concentration of nanoparticles that become diluted when mixed with other liquids applied to or naturally contained within the organism or organism part. Depending on the organism or organism part being treated, the nature of the nanoparticles being added, and the type of carrier being used, the antimicrobial composition may contain about 10 ppb (parts per billion) to about 100 ppm (parts per million) by weight of the antimicrobial composition, or about 15 ppb to about 90 ppm, or about 100 ppb to about 75 ppm, or about 500 ppb to about 60 ppm of metal nanoparticles by weight, or about 1 ppm to about 50 ppm, or about 2 ppm to about 25 ppm, or about 3 ppm to about 20 ppm metal nanoparticles by weight of the antimicrobial composition.

In some embodiments, the antimicrobial composition can also include one or more optional components or adjuvants to provide desired properties, including, but not limited to food, vitamins, minerals, antimicrobial agents, electrolytes, moisturizers, emollients, antiseptics, and/or plant extracts.

c. Incorporating Nanoparticles into Processing Water

In some embodiments, the metal nanoparticles are used in the processing water at each stage of a food provision chain. In one embodiment, metal nanoparticles are included in the water used for washing animals in preparation for slaughter. Having the metal nanoparticles in the washing water will introduce the nanoparticles for microbial control in this stage of the food processing. For example, in the scalding tanks for birds the bacteria can be as high as 10∧8 within 30 minutes. Introducing the metal nanoparticles into the scalding tanks will control the bacteria from pluming as the metal nanoparticles do not change at elevated temperatures. Also, the concentration of metal nanoparticles can vary with temperature gradients between the carcass and the hot water. In other processing stages, the use of metal nanoparticles in the processing water ensures microbial controls for water being pumped in, circulated internally, and discharged.

In some embodiments, the metal nanoparticles are included in the water used to wash fruits and vegetables after harvesting. In some embodiments, the metal nanoparticles are included in a final spray for appearance that is applied to fruits and/or vegetables destined for premium markets. The metal nanoparticles may be included in a concentration capable of mitigating ryzopus molds, penicillium molds, and other molds, in addition to bacteria such as salmonella, e. coli, campylobacter, clostridium bolutinum, etc. In some embodiments, a composition containing metal nanoparticles may also include spray aids such as citric acids, peracetic acid, boric acid, peroxides, etc. The metal nanoparticles used in conjunction with the spray aids enables efficacy of the spray aids at lower concentrations then may conventionally be used for microbial control.

The metal nanoparticles may be a processing aid, preventing buildup of microbes in the processing equipment without necessarily being a final ingredient in the product line. The metal nanoparticles may act as a preservative, preventing the buildup of unwanted microbes in the processing water, water tanks, the pipes and/or tubes routing the water, and in slaughtering areas. The metal nanoparticles may also prevent corrosion of equipment. Microbes can increase the pH of their environment, which can lead to corrosion of processing equipment. By preventing the buildup of microbes, the increase in pH does not occur and there is reduced corrosion, meaning the equipment lasts longer.

In some embodiments, the metal nanoparticles are effective at 0.5 mg/L to 10 mg/L concentrations (about 0.5 ppm to about 10 ppm), meaning they are far less of a toxic concern than competing peracetic acid, bromine chemistry, and peroxide chemistries. The peracetic acid, bromine chemistry, and peroxide chemistries may be limited in their concentrations due to the damage they cause to proteins, where the metal nanoparticles do not cause such damage. Metal nanoparticles thus may enhance the microbial control of peracetic acid, bromine chemistry, and peroxide chemistries at far lower concentrations than generally used. Metal nanoparticles have no microbial resistance as the mode of action is sulfur sequestering from the microbes, causing the microbes to shut down without lysing them. Adding metal nanoparticles with microwave induction increases local super heating of microbes to control them via flash heating using microwave and electron emission technologies.

d. Using Nanoparticles to Disinfect Food Processing Equipment

In some embodiments, the metal nanoparticles may be used in the food provision chain to disinfect equipment. In some embodiments, the metal nanoparticles may be included in a spray, fluid, or powder used in cleaning food processing equipment. The metal nanoparticles may be a processing aid, preventing buildup of unwanted microbes and maintain the sanitation of the food processing equipment.

e. Incorporating Nanoparticles into Food Product Packaging

In some embodiments, the metal nanoparticles may be incorporated on or in the packaging materials for food products, such as thermoplastic wraps, polystyrene trays, or other suitable food packaging materials. The use of the metal nanoparticles throughout the food processing chain ensures control of microbes in line with the tightened controls of the FDA and USDA.

In some embodiments, the metal nanoparticles are sprayed or coated onto already made packaging materials. In some embodiments, the metal nanoparticles are embedded into the package materials, such as thermoplastic wraps, polystyrene trays, solid plastics, polyurethanes, etc. In some embodiments, the embedded metal nanoparticles will come into contact with the food product contained in the packaging materials and prevent the buildup of unwanted microbes. The metal nanoparticles may act as a preservative, increasing the shelf-life of the packaged food product by preventing the buildup of unwanted microbes. The metal nanoparticles may prevent the buildup of unwanted microbes in the packaging and/or the food product itself. The packaged food product may be meat, fruit, vegetables, or other type of processed food product.

To manufacture packaging materials from thermoplastic materials, the polymer beads can be coated with metal nanoparticles, such as by dispersing the metal nanoparticles in a volatile solvent, applying the dispersion to the polymer beads, and allowing the solvent to evaporate. When the metal nanoparticle coated polymer beads are melted within forming equipment, such as an auger, extruder, or injection molding machine, the metal nanoparticles become distributed throughout the molten thermoplastic polymer and the packaging materials made therefrom.

In the case of two-part curable resins used to make packaging materials, metal nanoparticles can be included on one or both parts. When the two parts are mixed together, the metal nanoparticles are blended throughout the mixture and will solidify in place within whatever product the composition is shaped into. The portion of metal nanoparticles on the surface of the packaging materials will provide antimicrobial activity to prevent microbial growth on the package surface and the surface of the food product in contact with the packaging material.

f. Applying Nanoparticles to Food Products

In some embodiments, the metal nanoparticles may be applied to food products, such as meat and/or vegetables, to prevent or control microbial growth during processing, shipment and/or storage of the food products. For example, in some embodiments, the metal nanoparticles may be injected into the food product, such as into a meat product. The metal nanoparticles may act as a processing aid and/or may be a final ingredient in the product line. In some embodiments, the metal nanoparticles are applied directly to fruits and/or vegetables as a processing aid to prolong their shelf-life during harvesting, shipment, and storage. The metal nanoparticles may be included in the water fruits and/or vegetables are washed with or they may be included in a final spray for appearance applied to the fruits and/or vegetables destined for premium markets.

In some embodiments, the sequence of introduction to the food product is important. For example, when fermentation is a desired future process for the food product to undergo, the metal nanoparticles may be added to the food product at a time before the fermentation is desired. For example, the metal nanoparticles may be sprayed onto the food product prior to its shipment and storage in a grocery store/restaurant. The food product may then be washed and/or combined with other food products, thus diluting the concentration of the metal nanoparticles present. A fermentation agent may be added to the food product, now having a concentration of metal nanoparticles below the antimicrobial effective range. The fermentation process may then commence.

In some embodiments, the metal nanoparticles prevent the buildup of unwanted microbes prior to fermentation. Once diluted to a concentration below the antimicrobial effective range, the metal nanoparticles will not prevent the food product or products from being fermented. In some embodiments, the fermentation process may actually proceed faster than in the absence of the metal nanoparticles. In some embodiments, the metal nanoparticles prevent the buildup of unwanted microbes that would compete with the fermentation agent.

In some embodiments, an antimicrobial composition can be formulated so that the metal nanoparticles are included in a concentration so that a measured quantity of the nanoparticle composition, when applied onto or into food products, will provide a predetermined concentration or quantity of metal nanoparticles. The nanoparticle composition can have a higher concentration of nanoparticles that become diluted when mixed with other food products or upon processing of the food product (such as cooking).

Depending on the food product, the nature of the nanoparticles being added, and the type of carrier being used, the antimicrobial composition may contain about 10 ppb (parts per billion) to about 100 ppm (parts per million) by weight of the antimicrobial composition, or about 15 ppb to about 90 ppm, or about 100 ppb to about 75 ppm, or about 500 ppb to about 60 ppm of metal nanoparticles by weight, or about 1 ppm to about 50 ppm, or about 2 ppm to about 25 ppm, or about 3 ppm to about 20 ppm metal nanoparticles by weight of the antimicrobial composition.

In some embodiments, the antimicrobial composition can also include one or more optional components or adjuvants to provide desired properties, including, but not limited to food, vitamins, minerals, antimicrobial agents, electrolytes, moisturizers, emollients, antiseptics, and/or plant extracts.

### Example 1

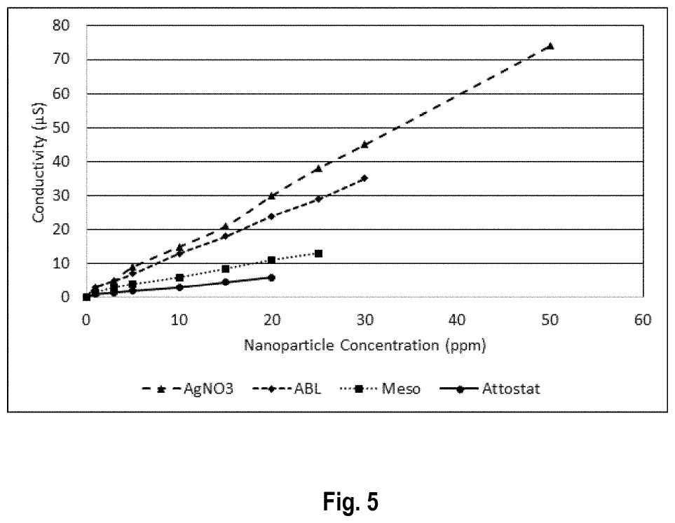

FIG. 5 illustrates the results of conductivity testing comparing various nanoparticle solutions and showing that spherical, metal nanoparticles according to the disclosed embodiments are nonionic. In Exhibit A, “Attostat” corresponds to nonionic, ground state, spherical silver nanoparticles formed by laser ablation such as described herein, “AgNO3” is silver nitrate, “Meso” represents a commercially available silver nanoparticle formulation with nanoparticles formed through a chemical reduction process, and “ABL” represents a commercially available silver nanoparticle formulation understood to be formed through an electrolysis process.

The results illustrate that the Attostat nanoparticle formulation had no significant or measurable ion release compared to any of the other tested nanoparticle formulations. It should be noted that the measured conductivity for Attostat nanoparticle formulations, even at the highest measured concentration of 16 ppm, remained low enough to be on par with typical conductivity measurements for high quality deionized water. This indicates that no metal ions could be detected.

### Example 2

An antibacterial efficacy test was carried out comparing an “Attostat” nanoparticle formulation (8 nm size) against silver nitrate and against the National Institute of Standards and Technology (NIST) Standard Nanocomposix 10 nm silver nanoparticles. The NIST nanoparticles are formed by a chemical reduction process that utilizes citrate as reducing and capping agent. The NIST nanoparticles have a conductivity similar to the “Meso” nanoparticles of Example 2, with detectable but low levels of silver ions. The NIST nanoparticles are of the type that have been found to result in nanoparticle-resistance over time after repeated passages.

Relative Light Unit (RLU) counts were recorded at 12 hours and 24 hours post treatment. RLU measurements were carried out using a Hygiena SystemSURE Plus V.2 SN067503 RLU meter with Hygenia AquaSnap TOTAL ATP Water Test Cat #U143 Lot #153019. Culturing media was Hardy Diagnostics Buffered Peptone Water Lot #118272. Samples were prepared with the nanoparticle treatments and then diluted with the media to provide the tested concentrations. The test organism (Microbiologics, E. coli, KwikStik, ATCC #51813, Ref #0791 K, Lot #791-1-6) was incubated in fresh Buffered Peptone Water growth media for 24 hours prior to exposure to the nanoparticle treatments. Tables 1 and 2 illustrate results of RLU counts 12 and 24 hours post nanoparticle treatment, respectively.

TABLE 1
RLU Counts at 12 Hours Post Exposure to Nanoparticle Treatment

| | Attostat 8 nm | NIST Standard | AgNO3 Silver |
|---|---|---|---|
| Concentration | Particles | Particles 10 nm | Nitrate |
| Control 0 ppm (mg/L) | 6256 | 7037 | 6731 |
| 0.25 ppm (mg/L) | 65 | 6908 | 80 |
| 0.5 ppm (mg/L) | 72 | 5416 | 75 |
| 1.0 ppm (mg/L) | 30 | 7189 | 84 |

TABLE 2
RLU Counts at 24 Hours Post Exposure to Nanoparticle Treatment

| | Attostat 8 nm | NIST Standard | AgNO3 Silver |
|---|---|---|---|
| Concentration | Particles | Particles 10 nm | Nitrate |
| Control 0 ppm (mg/L) | 7595 | 5421 | 7342 |
| 0.25 ppm (mg/L) | 25 | 5691 | 25 |
| 0.5 ppm (mg/L) | 8 | 3950 | 46 |
| 1.0 ppm (mg/L) | 30 | 3834 | 30 |

Tables 3 and 4 represent the data in terms of comparing each treatment to its respective control at 12 and 24 hours post treatment, respectively.

TABLE 3
RLU as percentage of control at 12 Hours Post Treatment

| | Attostat 8 nm | NIST Standard | AgNO3 Silver |
|---|---|---|---|
| Concentration | Particles | Particles 10 nm | Nitrate |
| Control 0 ppm (mg/L) | 100% | 100% | 100% |
| 0.25 ppm (mg/L) | 1.0% | 98.2% | 1.2% |
| 0.5 ppm (mg/L) | 1.1% | 77.0% | 1.1% |
| 1.0 ppm (mg/L) | 0.6% | 102.2% | 1.3% |

TABLE 4
RLU as percentage of control at 24 Hours Post Treatment

| | Attostat 8 nm | NIST Standard | AgNO3 Silver |
|---|---|---|---|
| Concentration | Particles | Particles 10 nm | Nitrate |
| Control 0 ppm (mg/L) | 100% | 100% | 100% |
| 0.25 ppm (mg/L) | 0.33% | 105% | 0.34% |
| 0.5 ppm (mg/L) | 0.11% | 72.9% | 0.62% |
| 1.0 ppm (mg/L) | 0.39% | 70.7% | 0.41% |

As shown, at all concentrations tested, the Attostat nanoparticles reduced the number of RLU counts to less than 1.5% from the control baseline at both the 12 hour and 24-hour measurement periods. Anything below 1.5% is below level of accurate detection and is considered a complete kill.

The Attostat nanoparticles effectively reduced RLU counts to below the 1.5% threshold at all tested concentrations. The NIST nanoparticles appeared to show a trend toward greater efficacy at higher concentrations, which would correspond to a normal diffusion model, but even at the highest tested concentration still only reached an RLU count of 70.7% of the initial control baseline at the 24-hour measurement.

The low antimicrobial efficacy of the NIST nanoparticles at the concentrations tested as compared to the silver nitrate could potentially be explained by the lower conductivity, and thus lower ion concentration, of the NIST nanoparticles as compared to the silver nitrate. However, the significant efficacy of the Attostat nanoparticles was surprising given the fact that the Attostat nanoparticles have significantly low to non-detectable levels of ions, even lower than the NIST particles. The Attostat nanoparticles continued to provide antimicrobial activity through the 24-hour testing period with no signs of reduced efficacy.

### Example 2

Spherical-shaped silver nanoparticles made by laser ablation so as to have no external bond angles or edges and which are nonionic and do not release silver ions, were tested to determine if they caused silver nanoparticle resistant bacteria. No such resistance was detected after 28 passages.

The study was entitled “Mutant generation testing on P. aeruginosa ATCC 15442, and E. coli ATCC 25922”. Two different types of spherical silver nanoparticles were tested: Silver Lot #Desktop Laser: Ag200917-104 (19 PPM) and Silver Lot #Industrial Laser: 171229-101 (16.8 PPM). The spherical-shaped silver nanoparticles made by ablation using the desktop laser had a narrow particle size distribution between 8-10 nm, and the spherical-shaped silver nanoparticles made by ablation using the industrial laser had a slightly less narrow particle size distribution between 8-12 nm,

The procedure for the study is outlined as follows:

### Bacteria Preparation

1. Streak bacteria onto tryptic soy agar (TSA) plates and incubate overnight 37° C.
2. Next day, inoculate 10 mL of silver with Mueller Hinton broth mix with one colony.

a. Desktop laser:
i. E. coli—Make a 4.75 ppm silver nanoparticle mix in the broth (2.5 mL Ag+7.5 mL broth).
ii. P. aeruginosa—Make a 4.75 ppm silver nanoparticle mix in the broth (2.5 mL Ag+7.5 mL broth).

b. Industrial laser:
i. E. coli—Make a 2 ppm silver nanoparticle mix in the broth (1.2 mL Ag+8.8 mL broth).
ii. P. aeruginosa—Make a 2 ppm silver nanoparticle mix in the broth (1.2 mL Ag+8.8 mL broth).
3. Incubate at 37° C. at 250 RPM 24-36 hours.
4. Monitor growth the next day.
5. Continue to serial passage in a new silver broth mixture with an inoculating loop into culture.
6. Every 5-7 days, streak out a loop of culture onto TSA plates to preserve passages then perform an MIC test on colonies to measure if the bacteria have generated resistance to the spherical silver nanoparticles.

The results of the study are as follows:

### Results MIC Values:

E. coli—Industrial laser sample: MIC held at 2 ppm out to serial passage 28.

DT laser sample: Culture stopped regenerating after passage 21. MIC held in previous passages.
P. aeruginosa—Industrial laser sample: MIC held at 2 ppm out to serial passage 28.

DT laser sample: Culture stopped regenerating after passage 21. MIC held in previous passages.

All negative and positive controls passed.

### Comparative Example

A similar test is made using conventional silver nanoparticles made using a chemical synthesis process. The silver nanoparticles have external bond angles and edges and release silver ions in water. Within 6 passages anti-silver resistance is apparent from increasing MIC values.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A method of controlling microbes and/or limiting microbial growth in a food processing chain, comprising:
introducing an antimicrobial nanoparticle composition into a stage of the food processing chain, the antimicrobial composition including:
a carrier; and
a plurality of nonionic metal nanoparticles formed by laser ablation dispersed within the carrier, the metal nanoparticles comprising spherical-shaped and/or coral-shaped nanoparticles having no external bond angles or edges and having a particle size and a particle size distribution selected so as to selectively and preferentially kill or deactivate one of a bacterium, a fungus, or a virus; and
applying the antimicrobial nanoparticle composition onto or into a substrate in the stage of the food processing chain and that contains or is at risk of containing microbes, the antimicrobial composition killing or deactivating the microbes
wherein the substrate forms part of and/or is located within a living area of an animal, a feeding apparatus, animal food and/or water, food processing water, food processing equipment, an animal prior to, during, or after being slaughtered, food packaging, or a food product.

2. The method of claim 1, wherein the substrate is a living animal.

3. (canceled)

4. The method of claim 1, wherein the substrate is selected from meat from a slaughtered animal or non-meat food product.

5-11. (canceled)

12. A method of controlling microbes and/or limiting microbial growth in a food processing chain, comprising:
introducing an antimicrobial nanoparticle composition into a stage of the food processing chain, the nanoparticle composition comprising
a carrier, and
a plurality of nonionic metal nanoparticles formed by laser ablation dispersed within the carrier, the metal nanoparticles comprising spherical-shaped and/or coral-shaped nanoparticles having no external bond angles or edges,
wherein introducing the antimicrobial nanoparticle composition into the stage of the food processing chain comprises one or more of:
introducing the nanoparticle composition into a living area of an animal,
applying the nanoparticle composition to a feeding apparatus,
applying the nanoparticle composition to animal food and/or water,
applying the nanoparticle composition to an animal prior to, during or after being slaughtered,
incorporating the nanoparticle composition into food processing water,
applying the nanoparticle composition to food processing equipment as a disinfectant,
incorporating the nanoparticle composition into food packaging, or
applying the nanoparticle composition directly to a food product.

13. The method of claim 12, wherein the nonionic metal nanoparticles prevent antimicrobial resistance to a greater degree than ionic metal nanoparticles formed by chemical synthesis so as to have external bond angles and edges.

14. The method of claim 13, wherein introducing the nanoparticle composition into a living area of an animal comprises spraying, misting, or coating the nanoparticle composition onto surfaces of the living area.

15. The method of claim 14, wherein one or more animals are present in the living area during introduction of the nanoparticle composition and wherein a surface of one or more animals is contacted by the antimicrobial nanoparticle composition and/or one or more animals inhale the nanoparticle composition.

16. The method of claim 12, wherein applying the nanoparticle composition to animal food and/or water comprises spraying or misting the nanoparticle composition onto animal feed.

17. The method of claim 12, wherein applying the nanoparticle composition to animal food and/or water comprises adding the nanoparticle composition to animal drinking water.

18. The method of claim 17, wherein the nanoparticle composition is added such that the drinking water includes the metal nanoparticles at a concentration of 10 ppb to 100 ppm.

19. The method of claim 12, wherein incorporating the nanoparticle composition into food processing water comprises adding the nanoparticle composition to scalding water and/or to pre-slaughter wash water.

20. The method of claim 12, wherein the nanoparticle composition is added to food processing water at a concentration of 0.5 ppm to 10 ppm.

21. The method of claim 12, wherein incorporating the nanoparticle composition into food packaging comprises spraying or coating the nanoparticle composition onto food packaging.

22. The method of claim 12, applying the nanoparticle composition directly to a food product comprises applying the nanoparticle composition to a meat, fruit, or vegetable product.

23. The method of claim 22, wherein the nanoparticle composition is a wash.

24. The method of claim 12, wherein the metal nanoparticles comprise gold nanoparticles, silver nanoparticles, or both.

25. The method of claim 12, wherein the metal nanoparticles comprise spherical-shaped nanoparticles, and wherein at least 99% of the spherical-shaped nanoparticles have a diameter within ±3 nm of the mean diameter or within 30% of the mean diameter, as measured using a z-average using dynamic light scattering (DLS).

26. The method of claim 12, wherein the coral-shaped nanoparticles have a particle size of about 15 nm to about 100 nm, each coral-shaped metal nanoparticle having a non-uniform cross section and a globular structure formed by multiple, non-linear strands joined together without right angles.

27. A method of controlling microbes and/or limiting microbial growth in a food processing chain, comprising:
introducing an antimicrobial nanoparticle composition into a stage of the food processing chain, the nanoparticle composition comprising
a carrier, and
a plurality of nonionic metal nanoparticles dispersed within the carrier at a concentration of 10 ppb to 100 ppm, wherein the metal nanoparticles comprise spherical-shaped nanoparticles and optionally coral-shaped nanoparticles, wherein the metal nanoparticles comprise gold nanoparticles, silver nanoparticles, or both, wherein the metal nanoparticles comprise spherical-shaped nanoparticles, and wherein at least 99% of the spherical-shaped nanoparticles have a diameter within ±3 nm of the mean diameter or within 30% of the mean diameter, as measured using a z-average using dynamic light scattering (DLS),
wherein introducing the nanoparticle composition into the stage of the food processing chain comprises one or more of:
introducing the nanoparticle composition into a living area of an animal,
applying the nanoparticle composition to a feeding apparatus,
applying the nanoparticle composition to animal food and/or water,
incorporating the nanoparticle composition into food processing water,
applying the nanoparticle composition to food processing equipment as a disinfectant,
incorporating the nanoparticle composition into food packaging, or
applying the nanoparticle composition directly to a food product.

28. The method of claim 27, wherein the nonionic metal nanoparticles prevent antimicrobial resistance to a greater degree than ionic metal nanoparticles.
